(19) United States
(12) Patent Application Publication
(10) Pub. No.: US 2022/0414755 A1
(43) Pub. Date: Dec. 29, 2022

(54) METHOD, DEVICE, AND SYSTEM FOR PROVIDING FASHION INFORMATION

(71) Applicant: ODD CONCEPTS INC., Seoul (KR)

(72) Inventor: Ae Ri YOO, Namyangju-si (KR)

(73) Assignee: ODD CONCEPTS INC., Seoul (KR)

(21) Appl. No.: 17/780,790

(22) PCT Filed: Nov. 26, 2020
(86) PCT No.: PCT/KR2020/016970

§ 371 Date: May 27, 2022

(30) Foreign Application Priority Data
Nov. 29, 2019 (KR) 10-2019-0156779

(51) Int. Cl. G06Q 30/06

(52) U.S. Cl. CPC G06Q 30/0643; G06Q 30/0625

(57) ABSTRACT

The present invention relates to a method, a device, and a system for providing fashion information. Particularly, the system for providing fashion information, of the present invention, comprises: a sample data generation unit for generating sample data in which the same fashion items of various sizes are matched according to human body information; a sample data storage unit for storing the sample data; and a predictive fit data providing unit for receiving, from a user device, fashion item information and user body information, and generating predictive fit data in reference to the sample data stored in the sample data storage unit, wherein the predictive fit data can be referred to size or fit when a user selects the fashion items.

### CROSS REFERENCE TO RELATED APPLICATIONS

This application is a National Stage of International Application No. PCT/KR2020/016970 filed Nov. 26, 2020, claiming priority based on Korean Patent Application No. 10-2019-0156779 filed Nov. 29, 2019.

### TECHNICAL FIELD

The present invention relates to a method of providing a fit predicted when wearing a fashion item. Specifically, the present invention relates to a method, a device, and a computer program for providing predictive fit data that are capable of generating sample data through models having various heights, weights, and body characteristics wearing a specific fashion item or through three dimensional (3D) scanning, and providing a predictive fit on the basis of user body information.

### BACKGROUND ART

With the recent increase in the wired and wireless Internet environments, business transactions such as public relations and sales happening online are becoming more active. In this regard, when a buyer finds a product that he/she likes while viewing a magazine, blog, or YouTube video on a desktop or mobile terminal connected to the Internet, the buyer searches for the name of the product, etc. and makes a purchase.

In this case, the user determines whether the product is suitable for him/her on the basis of a wearing shot of a model who wears the product in an online shopping mall. For example, the user compares the model's height, weight, skin color, proportions, arm length, waist size compared to the thighs, and thickness of the thighs with the body characteristics of the user, and determines whether the product is suitable for the user.

However, compared to trying on a product in an offline store, the user may have difficulty accurately determining whether the clothes are really suitable for him or her by only making an abstract comparison in an online shopping mall. Human bodies have different heights, weights, and body characteristics, and in particular, there are not only numerically quantifiable factors such as height and weight, but also a “fit,” which is a feeling that a human is given when wearing a specific product, which may not be quantified numerically, and even bodies with the same height and weight may show different fits.

As a result, a consumer who has received a product may be more likely to refund or exchange the product or leave the product in the closet when the fit is different from what he/she expected. An apparel company may receive negative reviews and evaluations from consumers, which may damage their brand image and lead to reduced sales. Consumers may also experience opportunity costs from refunding or exchanging products, compared to when purchasing a product after trying on the product directly at an offline store or purchasing and keeping a desired product.

As such, there is a need for both the consumers and sellers to be provided with data on a predictive fit in a more intuitive user interface (UI) environment for online product images.

### DISCLOSURE OF INVENTION

### Technical Problem

The present invention is to solve the above-mentioned problem, it is directed to provide predictive fit data that reduces errors in fit that may differ between users even for a specific fashion item having the same size.

Furthermore, it is directed to collect user body information through a camera installed in an offline store and provide predictive fit data as user-customized data through the user body information.

### Technical Solution

The present invention relates to a method, device, and system for providing fashion information. Specifically, the system for providing fashion information according to an embodiment of the present invention includes a sample data generation unit configured to generate sample data in which the same fashion items of various sizes are matched according to human body information, a sample data storage unit configured to store the sample data, and a predictive fit data providing unit configured to, upon receiving fashion item information and user body information from a user device, generate predicted fit data with reference to the stored sample data and provide the user device with the generated predictive fit data, wherein the user body information includes basis body information and body characteristic information, the body characteristic information includes at least one among information about a proportion of each part of a body of a user, information about a skin color of the user, and information about a skin tone of the user, and the predictive fit data is data to be referred to by the user for a size or fit when selecting the fashion item, the predictive fit data including sample data that is retrieved in the stored sample data on the basis of the fashion item information and the user body information.

The method of providing fashion information according to an embodiment of the present invention includes generating, by a sample data generation unit, sample data in which the same fashion items of various sizes are matched according to human body information, storing, by a sample data storage unit, the sample data, generating, by a predictive fit data providing unit, upon receiving fashion item information and user body information from a user device, predictive fit data with reference to the stored sample data and providing the user device with the generated predictive fit data, wherein the user body information includes basic body information and body characteristic information, the body characteristic information includes at least one among information about a proportion of each part of a body of a user, information about a skin color of the user, and information about a skin tone of the user, and the predictive fit data is referred to by the user for a size or fit when selecting the fashion item, the predictive fit data including sample data that is retrieved in the stored sample data on the basis of the fashion item information and the user body information.

### Advantageous Effects

According to the present invention, there is an effect of reducing errors in fit that can differ between users for a specific fashion item having the same size.

Furthermore, there is an effect of collecting user body information through a camera installed in an offline store and providing predictive fit data as user-customized data through the user body information.

### DESCRIPTION OF DRAWINGS

FIG. 1 is a diagram for describing a system for providing fashion information according to an embodiment of the present invention.

FIG. 2 is a diagram for describing basic sample data according to an embodiment of the present invention.

FIG. 3 is a diagram for describing model sample data according to an embodiment of the present invention.

FIG. 4 is a flowchart for describing a basic operation of a system for providing fashion information according to an embodiment of the present invention.

FIG. 5 is a flowchart for describing an embodiment of operation S401 of FIG. 4 in detail.

FIG. 6 is a flowchart for describing another embodiment of operation S401 of FIG. 4 in detail.

FIG. 7 is a flowchart for describing an embodiment of the present invention implemented in an offline store

### MODES OF THE INVENTION

Embodiments according to the concept of the present invention disclosed in the present specification or application are disclosed herein in relation to specific structural and functional details, which are however merely representative for purposes of describing the example embodiments of the present invention, and the example embodiments of the present invention may be embodied in many alternate forms and are not to be construed as limited to the example embodiments of the present invention set forth herein.

While the embodiments according to the concept of the present invention are susceptible to various modifications and alternative forms, specific embodiments thereof are shown by way of example in the drawings and will herein be described in detail. However, it should be understood that there is no intent to limit the invention to the particular forms disclosed, rather the invention is to cover all modifications, equivalents, and alternatives falling within the spirit and scope of the invention.

It should be understood that, although the terms first, second, etc. may be used herein to describe various elements, these elements are not limited by these terms. These terms are only used to distinguish one element from another element. For example, without departing from the scope of the present invention, a first element could be termed a second element, and, similarly, a second element could be termed a first element.

It should be understood that when an element is referred to as being “connected” or “coupled” to another element, the element can be directly connected or coupled to another element or intervening elements may be present. Conversely, when an element is referred to as being “directly connected” or “directly coupled” to another element, there are no intervening elements present. Other words used to describe a relationship between elements should be interpreted in a like fashion (i.e., “between” versus “directly between,” “adjacent” versus “directly adjacent,” etc.).

The terminology used herein is for the purpose of describing particular embodiments only and is not intended to limit the invention. As used herein, the singular forms “a,” “an,” and “one” are intended to include the plural forms as well, unless the context clearly indicates otherwise. It should be further understood that the terms “comprises,” “comprising,” “includes,” and/or “including,” when used herein, specify the presence of stated features, integers, steps, operations, elements, components and/or groups thereof, and do not preclude the presence or addition of one or more other features, integers, steps, operations, elements, components, and/or groups thereof.

Unless otherwise defined, all terms including technical and scientific terms used herein have the same meaning as commonly understood by one of ordinary skill in the art to which this invention belongs. It should be further understood that terms, such as those defined in commonly used dictionaries, should be interpreted as having a meaning that is consistent with their meaning in the context of the relevant art and are not to be interpreted in an idealized or overly formal sense unless expressly so defined herein.

In the description of the embodiments, the detailed description of constructions that are well known in the field to which the present invention pertains and are not directly related to the present invention will be omitted. This is to avoid making the subject matter of the present invention unclear and more clearly convey the subject matter by omitting unnecessary description.

Hereinafter, the present invention will be described in detail by describing exemplary embodiments of the present invention with reference to the accompanying drawings. Hereinafter, embodiments of the present invention will be described in detail with reference to the accompanying drawings.

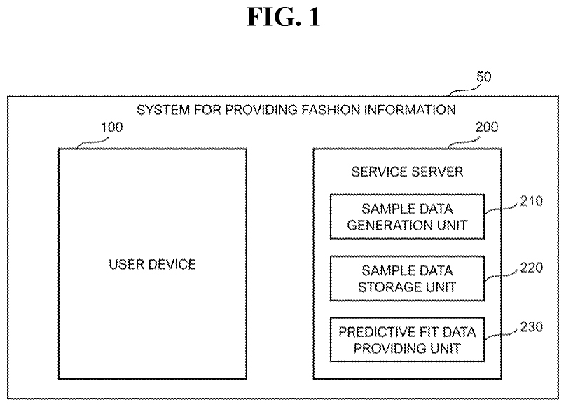

FIG. 1 is a diagram for describing a system for providing fashion information according to an embodiment of the present invention.

Referring to FIG. 1, a system 50 for providing fashion information may include a user device 100 and a service server 200. The user device 100 may include a mobile phone, a smart phone, a Moving Picture Experts Group (MPEG) audio layer-3 (MP3) player, a laptop computer, a desktop computer, a game console, a television (TV), a tablet personal computer (PC), an in-vehicle infotainment system, or the like.

A user may select a preferred fashion item from an online shopping mall in the user device 100 and transmit the preferred fashion item to the service server 200. The service server 200 may provide the user with predictive fit data in which the fashion item selected by the user is coordinated, and the user may refer to the predictive fit data when determining whether to purchase the corresponding fashion item.

The predictive fit data may be data that may be referred to by a user for size or fit when selecting a fashion item. Existing online shopping malls merely provide sizes in which various body characteristics of humans are not reflected and which are expected to fit roughly according to heights and weights.

However, even users having the same height and weight may show completely different fits depending on specific body characteristics. A fit may be information expressing a feeling of a human when a specific product is worn. Users may desire different fits depending on the style pursued by each user. Therefore, the existing method of simply recommending a size according to height and weight may not accurately reflect the needs of users who desire to find fashion items that match the users.

To this end, the service server 200 may receive fashion item information selected by the user and user body information from the user device 100, generate predictive fit data by referring to sample data, and transmit the generated predictive fit data to the user device 100.

Referring to FIG. 1, the service server 200 may include a sample data generation unit 210, a sample data storage unit 220, and a predictive fit data providing unit 230.

The sample data generation unit 210 may generate sample data in which the same fashion items of various sizes are matched according to body information of humans. The sample data may be used to generate predictive fit data according to user body information including the height, weight, and detailed body information of a user.

In an embodiment, the sample data may be generated by models directly wearing the same fashion items of all sizes. In this case, the sample data may be divided into basic sample data and model sample data.

For the sake of convenience in description, information about the heights and weights may be classified and described as basic sample data, and information about other body characteristics may be classified and described as model sample data, but both the basic sample data and the model sample data may be included in the sample data and may be an indistinguishable concept according to an embodiment.

The basic sample data may be sample data generated by models having various heights and weights directly wearing the same fashion items of all sizes.

For example, in the case of male models, representative sample models may be selected at each predetermined interval (e.g., 5 cm) in a distribution of 160 cm to 190 cm, and each of the representative sample models may directly wear the same fashion items of all sizes. Images of the models wearing the fashion items may be captured as photos and stored in the sample data storage unit 220 as basic sample data.

According to an embodiment, the representative sample models may be selected from a weight distribution in a specific range. For example, in the case of male models, representative sample models may be selected at each predetermined interval (e.g., 5 kg) in a distribution from 50 kg to 90 kg, and each of the representative sample models may directly wear the same fashion items of all sizes.

According to an embodiment, basic sample data in which both the height and the weight are reflected may be generated. In the example of the male models above, models of 160 cm may be subdivided according to weights of 50 kg to 90 kg to select representative sample models, models of 165 cm may be subdivided according to weights of 50 kg to 90 kg to select representative sample models, and models of 170 cm may be subdivided according to weights of 50 kg to 90 kg to select representative sample models, so that representative sample models may be selected by subdividing the models having the same height according to the weights.

The model sample data may be data generated by models having various body characteristics directly wearing the same fashion items of all sizes. Body characteristics may include long arms, thin thighs, a waist circumference larger than the thighs, a lower body longer than an upper body, broad shoulders, thin ankles, etc., which is information that greatly differs between individuals, or is difficult to represent numerically, or depends on a person's subjective feeling.

Models even with the same height and weight may show completely different fits depending on the body characteristics. For example, model A and model B have the same height and weight, while model A has a larger lower body than upper body and model B has a larger upper body than lower body. In this case, model A may be suitable for clothes of a relatively large size for bottoms and clothes of a relatively small size for tops, compared to people having the same height and weight as model A. On the other hand, model B may be suitable for clothes of a relatively small size for bottoms and clothes of a relatively large size for tops, compared to people having the same height and weight as model B.

The model sample data may include wearing shots of models having various body characteristics to provide users with more accurate predictive fit data. The more body characteristics reflected in the model sample data, the more accurate predictive fit data may be viewed by the user. Accordingly, the service server 200 may update the model sample data at any point in time or periodically to provide predictive fit data in which various body characteristics or the latest trends are reflected.

In another embodiment, the sample data may be generated through 3D scanning data. That is, the sample data may be obtained from body 3D scanning data of models having various heights, weights, and body characteristics and fashion item 3D scanning data rather than from models directly wearing fashion items.

3D scanning data may be data regarding a 3D image of an object captured by calculating the depth value of each pixel of an image, for example, using a 3D stereo camera and a 3D depth camera, which may not be performable in the conventional two dimensional (2D) methods.

Specifically, the sample data generation unit 210 may generate body 3D scanning data corresponding to 3D images of bodies of models having various heights, weights, and body characteristics. In addition, the sample data generation unit 210 may generate fashion item 3D scanning data corresponding to 3D images of fashion items.

Thereafter, the sample data generation unit 210 may calculate vector values included in the body 3D scanning data and the fashion item 3D scanning data to extract a feature vector value including information about a predictive fit.

For the extraction of the feature vector value, various techniques may be adopted. For example, the sample data generation unit 210 may determine what kind of fit is derived when the body 3D scanning data overlaps the fashion item 3D scanning data, depending on the position of the shoulder line, the amount of a waist margin, how short or long the sleeves are, how much the top covers the bottom, the degree to which the ankles are exposed, how many wrinkles are formed on the clothes from wearing, etc.

Feature labels corresponding to the feature vector values may be generated as sample data together with user body information and fashion item information. The feature labels may be text expressing a fit, which is a feeling given to humans by a specific fashion item. For example, the feature label may include an over-fit label, a slim fit label, a formal fit label, a loose fit label, a just-fit label, a basic fit label, and the like.

According to still another embodiment of the present invention, the fashion item 3D data and the body 3D data may include an image designed through an image editing program, such as Photoshop, as well as an image actually captured through a camera.

Capturing and editing all of body characteristics and fashion items with a camera may require much time and effort. By generating fashion item 3D scanning data and body 3D scanning data through an image editing program, an effect of efficiently constructing a database of sample data in a short period of time may be provided.

According to an embodiment of the present invention, the service server 200 may define a feature label for a fit that may be felt by a human, and generate sample data on the basis of a directly captured wearing shot and/or 3D scanning data. A machine learning model in which the above process of generating sample data from feature labels, wearing shots, and 3D scanning data is learned by a neural network model may be generated.

Machine learning is one field of artificial intelligence and may be defined as a system for learning based on empirical data, performing predictions, and improving the performance thereof and a set of algorithms for the system. A model used by the service server 200 may be a model of such machine learning that uses one of a deep neural network (DNN), a convolutional deep neural network (CNN), a recurrent neural network (RNN), and a deep belief network (DBN).

According to another embodiment of the present invention, the service server 200 may learn characteristics of images corresponding to sample data to form an initial neural network model, and apply a large amount of fashion item images, wearing shots, or 3D scanning data to the initial neural network model so that the neural network model becomes more precise.

Meanwhile, according to still another embodiment of the present invention, the service server 200 may apply feature labels to a neural network model formed in a hierarchical structure including a plurality of layers without separate learning of the sample data.

In addition, the service server 200 may assign feature information of a fashion item image with a weight according to a request of a corresponding layer, and use the processed feature characteristic information to cluster fashion item images, and assign a clustered image group with feature label information that is interpreted ex post facto, such as an over-fit feeling, a just-fit feeling, a slim fit feeling, and the like.

The sample data storage unit 220 may store the sample data generated by the sample data generation unit 210. The sample data stored in the sample data storage unit 220 may provide the predictive fit data providing unit 230 with sample data when information about a fashion item selected by the user and body information of the user are received from the user device 100.

The sample data stored in the sample data storage unit 220 may be updated periodically to reflect more diverse pieces of body information and to reflect information about the fit generated or deleted over time.

The predictive fit data providing unit 230 may receive fashion item information and user body information from the user device 100, refer to the sample data stored in the sample data storage unit 220, and generate predictive fit data.

The user body information may include information about the height, weight, and/or body characteristics of the user. The predictive fit data providing unit 230 may search for sample data including the user body information in the sample data storage unit 220, and provide the user device 100 with the retrieved sample data as predictive fit data.

Meanwhile, the user body information may include information about the skin tone of the user. Skin tone may be an important factor in determining a fashion item. Even the same fashion item may give different feelings when the fashion item is worn by a person with relatively light skin and when it is worn by a person with darker skin.

For example, the primary colors red, blue, and yellow may not suit those with dark skin tones. Wearing clothes that are suited to the user's skin tone may provide an effect of looking more lively and healthy.

Accordingly, the service server 200 may receive information about the skin tone of the user as a body characteristic, match a color determined to be well suited to the user's received skin tone, and provide the color as predictive fit data to the user.

The predictive fit data providing unit 230 may determine sample data among which information about height and weight or skin tone is the closest to the user body information received from the user as the body information of the user, and provide the user with the corresponding sample data as predictive fit data. In addition, the predictive fit data providing unit 230 may provide the user with sample data that includes detailed body characteristics of the user, such as long arms, thin thighs, and a waist circumference larger than the thighs, in common, as predictive fit data.

In this case, sample data having a largest number of body characteristics included in common may be provided to the user as representative predictive fit data, or sample data may be arranged in descending order of the largest number of body characteristics included in the sample data and provided to the user, or all sample data including at least one body characteristic may be provided to the user as predictive fit data.

According to the embodiment of the present invention, a fit to be provided when a model of a size similar to the user wears corresponding clothes in an online shopping mall may be estimated. Therefore, while a specific fashion item having the same size may provide different fits between users, an effect of reducing errors in fit may be reduced.

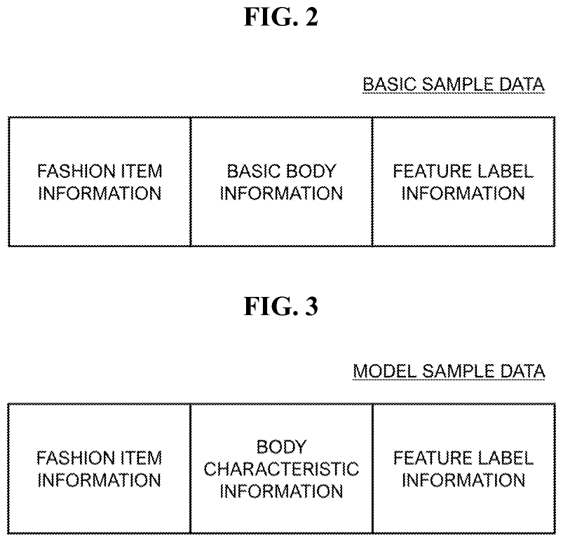

FIG. 2 is a diagram for describing basic sample data according to an embodiment of the present invention.

Referring to FIG. 2, basic sample data may include fashion item information, basic body information, and feature label information. The basic sample data may be sample data generated by models having various heights and weights directly wearing the same fashion items of all sizes.

The service server 200 may be configured to, based on user body information received from the user device 100, generate predictive fit data with reference to the sample data. In this case, for information about the height and weight (basic body information) in the user body information, the basic sample data may be referred to.

When a user desires to purchase a specific fashion item, first, the user may request “a fit derived” when “a body having the same or similar height and weight as the user” wears “the fashion item selected by the user” from the service server 200. The basic sample data may store “basic body information about heights and weights,” “fashion item information,” and “feature label information” to match each other in advance to comply with a request of a user.

Thereafter, the service server 200 may be configured to, upon receiving fashion item information and user body information from the user device 100, search for basic sample data including the received fashion item information and user body information, and provide the user device 100 with feature label information included in the retrieved basic sample data as predictive fit data.

FIG. 3 is a diagram for describing model sample data according to an embodiment of the present invention.

Referring to FIG. 3, model sample data may include fashion item information, characteristic body information, and feature label information. The model sample data may be data generated by models having various body characteristics directly wearing the same fashion items of all sizes. The body characteristics may include long arms, thin thighs, a waist circumference larger than the thighs, a lower body longer than a upper body, broad shoulders, thin ankles, etc., which is information that greatly differs between individuals, or is difficult to represent numerically, or depends on a person's subjective feeling.

The service server 200 may be configured to, based on the user body information received from the user device 100, generate predictive fit data with reference to the sample data. In this case, for the above-described information about body characteristics (body characteristic information) in the user body information, the model sample data may be referred to.

When a user desires to purchase a specific fashion item, first, the user may request “a fit derived” when “a body having the same or similar body characteristics as the user” wears “the fashion item selected by the user” from the service server 200. The model sample data may store “body characteristic information about body characteristics,” “fashion item information,” and “feature label information” to match each other in advance to comply with a request of a user.

Thereafter, the service server 200 may be configured to, upon receiving fashion item information and user body information from the user device 100, search for model sample data including the received fashion item information and user body information, and provide the user device 100 with feature label information included in the retrieved model sample data as predictive fit data.

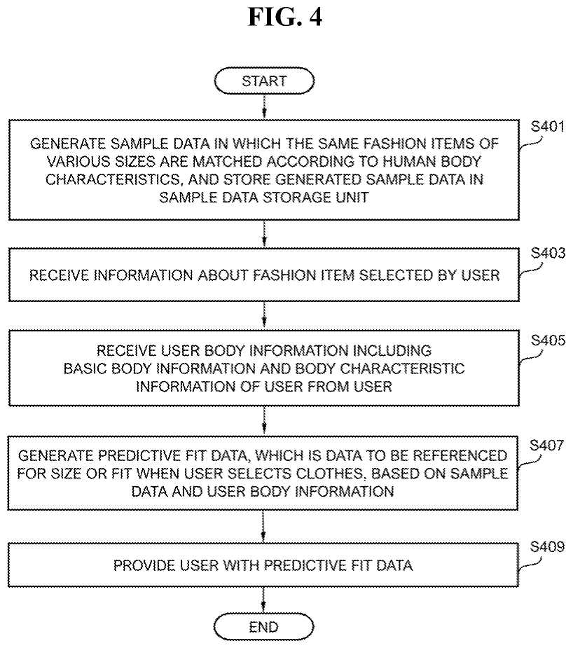

FIG. 4 is a flowchart for describing a basic operation of a system 50 for providing fashion information according to an embodiment of the present invention.

Referring to FIG. 4, in operation S401, the service server 200 may generate sample data in which the same fashion items of various sizes are matched according to human body characteristics, and may store the generated sample data in the sample data storage unit 220.

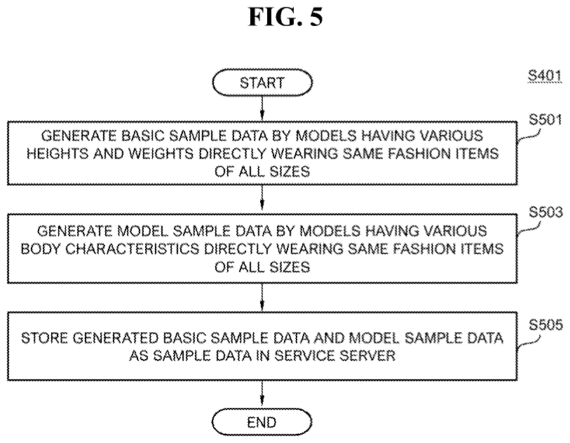

In an embodiment, the sample data may be generated by models directly wearing all sizes of the same fashion item. In this case, the sample data may be divided into basic sample data and model sample data. A process of generating the sample data by models directly wearing fashion items will be described in detail with reference to FIG. 5 described below.

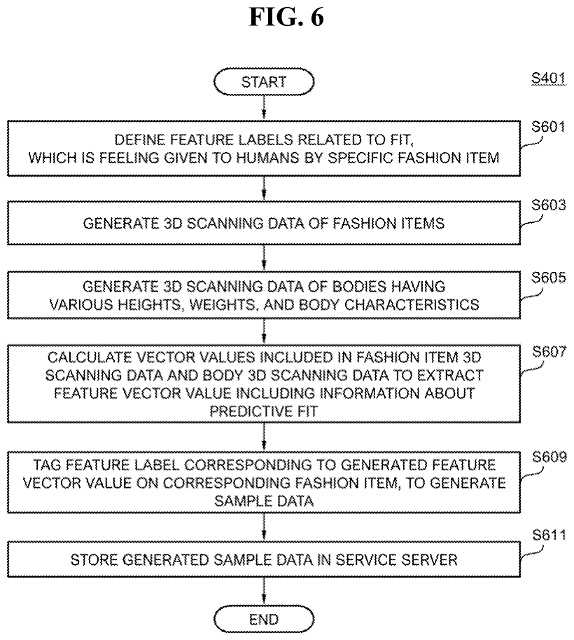

In another embodiment, the sample data may be generated through 3D scanning data. That is, the sample data may be acquired from body 3D scanning data of models having various heights, weights, and body characteristics and fashion item 3D scanning data rather than models directly wearing fashion items. A process of generating the sample data through 3D scanning data will be described in detail with reference to FIG. 6 below.

In operation S403, the service server 200 may receive information about a fashion item selected by a user.

A user may select a preferred fashion item while searching for fashion items in an online shopping mall, Internet magazine, website, or blog. Information about the fashion item selected by the user may be transmitted to the service server 200. The service server 200 may transmit a request to input user body information to the user device 100 to provide user-customized predictive fit data.

In operation S405, the service server 200 may receive user body information including basic body information and body characteristic information of the user from the user.

The basic body information may be body information about the height and weight, and the body characteristic information may include long arms, thin thighs, a waist circumstance larger than the thighs, a lower body longer than an upper body, broad shoulders, thin ankles, etc., in addition to the height and weight, which is information that greatly differs between individuals, or is difficult to represent numerically, or depends on a person's subjective feeling.

Meanwhile, the user body information may include information about the skin tone of the user. Skin tone may be an important factor in determining a fashion item. Even the same fashion item may have different feelings when the fashion item is worn by a person with relatively light skin and when it is worn by a person with darker skin.

For example, the primary colors red, blue, and yellow may not suit those with dark skin tones. Wearing clothes that are suited to the user's skin tone may have an effect of making them look more lively and healthy.

Accordingly, the service server 200 may receive information about the skin tone of the user as a body characteristic, match a color determined to be well suited to the user's received skin tone, and provide the color as predictive fit data to the user.

In operation S407, the service server 200 may generate predictive fit data, which is data that may be referred to for size or fit when the user selects clothes, on the basis of the sample data and the user body information.

The sample data may include information about a fashion item for which the user desires to identify whether the fashion item suits the user, user body information including the height, weight, and body characteristics, and feature label information about a fit that may be derived when the user wears the fashion item.

The service server 200 may receive user body information of the user and information about a fashion item selected by the user from the user device 100, and search for sample data including both the user body information and the fashion item information. Feature label information included in the retrieved sample data may be provided to the user as predictive fit data.

It may be practically impossible to store user body information of all users. Accordingly, when body characteristics that exactly match with the user are not stored, in the case of body information that may be quantified such as the height and weight, the service server 200 may search for body information having the closest values.

Body characteristics that may not be quantified, such as long arms, thin thighs, and a waist circumference larger than the thighs, may be retrieved from the service server 200 when the body characteristics are predefined as feature label information, but otherwise, the body characteristics may be newly added as feature label information by updating the service server 200.

In operation S409, the service server 200 may provide the user with the predictive fit data. The predictive fit data may be feature label information in the sample data when the fashion item and the user body information match the sample data.

The predictive fit data according to the embodiment of the present invention may be provided as predictive fit data in which various body characteristics of a human are reflected in addition to the height and weight. Therefore, while a fashion item having the same size may provide different fits between users, there is an effect of reducing an error in the fits.

FIG. 5 is a flowchart for describing an embodiment of operation S401 of FIG. 4 in detail.

FIG. 5 is a flowchart for describing an embodiment in which sample data is generated by models directly wearing fashion items. Hereinafter, for the sake of convenience in description, information about the height and weight is classified and described as basic sample data, and information about other body characteristics is classified and described as model sample data, but both the basic sample data and the model sample data may be included in the sample data and may be an indistinguishable concept according to an embodiment.

In operation S501, the service server 200 may generate basic sample data by models having various heights and weights directly wearing the same fashion items of all sizes.

For example, in the case of male models, representative sample models may be selected at each predetermined interval (e.g., 5 cm) in a distribution of 160 cm to 190 cm, and each of the representative sample models may directly wear the same fashion items of all sizes. Images of the models wearing the fashion items may be captured as photos and stored in the service server 200 as basic sample data.

According to an embodiment, the representative sample models may be selected from a weight distribution in a specific range. For example, in the case of male models, representative sample models may be selected at each predetermined interval (e.g., 5 kg) in a distribution from 50 kg to 90 kg, and each of the representative sample models may directly wear the same fashion items of all sizes.

According to an embodiment, basic sample data in which both the height and the weight are reflected may be generated. In the example of the male models above, models of a height of 160 cm may be subdivided according to weights of 50 kg to 90 kg to select representative sample models, models of a height of 165 cm may be subdivided according to weights 50 kg to 90 kg to select representative sample models, and models of a height of 170 cm may be subdivided according to the weights of 50 kg to 90 kg to select representative sample models, so that representative sample models may be selected by subdividing the models having the same height according to the weights.

In operation S503, the service server 200 may generate model sample data by models having various body characteristics directly wearing the same fashion items of all sizes.

Even models with the same height and weight may show completely different fits depending on the body characteristics. For example, model A and model B have the same height and weight, while model A has a larger lower body than upper body and model B has a larger upper body than lower body. In this case, model A may be suitable for clothes of a relatively large size for bottoms and clothes of a relatively small size for tops, compared to people having the same height and weight as model A. On the other hand, model B may be suitable for clothes of a relatively small size for bottoms and clothes of a relatively large size for tops, compared to people having the same height and weight as model B.

The model sample data may include wearing shots of models having various body characteristics to provide a user with more accurate predictive fit data. The more body characteristics reflected in the model sample data, the more accurate predictive fit data may be viewed by the user. Accordingly, the service server 200 may update the model sample data periodically to provide predictive fit data in which various body characteristics or the latest trends are reflected.

In operation S505, the service server 200 may store the generated basic sample data and model sample data as sample data in the service server 200.

FIG. 6 is a flowchart for describing another embodiment of operation S401 of FIG. 4 in detail.

FIG. 6 is a flowchart of describing a process in which sample data is generated through 3D scanning data. That is, the sample data may be obtained from body 3D scanning data of models having various heights, weights, and body characteristics and fashion item 3D scanning data rather than from models directly wearing fashion items.

Specifically, in operation S601, the service server 200 may define feature labels related to a fit, which is a feeling given to humans by a specific fashion item, in advance. Specific labels may include an over-fit label, a slim fit label, a formal fit label, a loose fit label, a just-fit label, a basic fit label, and the like.

In operation S603, the service server 200 may generate 3D scanning data of fashion items. 3D scanning data may be data regarding a 3D image of an object captured by calculating the depth value of each pixel of an image, for example, using a 3D stereo camera and a 3D depth camera, which may not be performable in the conventional two dimensional (2D) methods.

Specifically, the service server 200 may capture images of fashion items from various angles and generate fashion item 3D scanning information that enables volumic checking of the sizes of fashion items, such as the total length, shoulder width, chest section, sleeve length, waist circumference, thigh section, hem section, crotch length, and the like.

In operation S605, the service server 200 may generate body 3D scanning data corresponding to 3D images of bodies of models having various heights, weights, and body characteristics.

Since the captured 3D scanning data may be repeatedly used whenever needed when generating sample data, an initial single capturing of body 3D scanning data of detailed body information is sufficient.

When generating a database of initial sample data, it may be practically difficult to reflect all body information. Therefore, new 3D scanning data may be generated at any time or periodically, and the sample data may be updated at a later time.

In addition, although not shown in the drawings, the fashion item 3D data and the body 3D data may include an image designed through an image editing program, such as Photoshop, as well as an image actually captured through a camera.

Capturing and editing all of body characteristics and fashion items with a camera may require much time and effort. By generating fashion item 3D scanning data and body 3D scanning data through an image editing program, an effect of efficiently constructing a database of sample data in a short period of time may be provided.

In operation S607, the service server 200 may calculate vector values included in the fashion item 3D scanning data and the body 3D scanning data to extract a feature vector value including information about a predictive fit.

For the extraction of the feature vector value, various techniques may be adopted. For example, the service server 200 may determine what kind of fit is derived when the body 3D scanning data overlaps the fashion item 3D scanning data, depending on the position of the shoulder line, the amount of a waist margin, how short or long the sleeves are, how much the top covers the bottom, the degree to which the ankles are exposed, how many wrinkles are formed on the clothes from wearing, etc.

Feature labels corresponding to the feature vector values may be generated as sample data together with user body information and fashion item information. The feature label may be text expressing a fit, which is a feeling given to humans by a specific fashion item. For example, the feature label may include an over-fit label, a slim fit label, a formal fit label, a loose fit label, a just-fit label, a basic fit label, and the like.

In operation S609, the service server 200 may tag a feature label corresponding to the generated feature vector value on a fashion item corresponding thereto, to generate sample data. The sample data may include fashion item information, body information including basic body information and body characteristic information, and feature label information.

In operation S611, the service server 200 may store the generated sample data in the service server 200. The sample data stored in the service server 200 may be used when a user requests predictive fit data or when predictive fit data is provided as needed. The sample data may be updated at any time or periodically to reflect the latest fit trends and more diverse body characteristics.

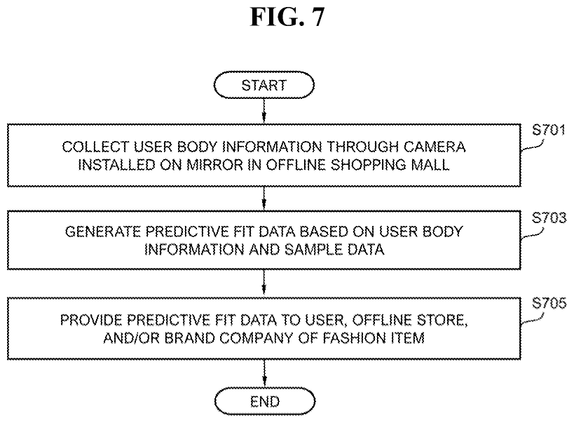

FIG. 7 is a flowchart for describing an embodiment of the present invention implemented in an offline store.

Referring to FIG. 7, in operation S701, the service server 200 may store body information of a user collected through a camera installed on a mirror of an offline store.

When a user wears a fashion item in an offline store and looks at a mirror, a camera installed on the mirror may take a wearing shot of the user. The wearing shot may be taken at the same time as the user looks at the mirror, after a certain amount of time has elapsed from the point of looking at the minor, or periodically while the user is looking at the mirror. However, this is only an example, and the time point of taking a wearing shot may be performed in various ways.

The collected user body information may be transmitted to the service server 200. In operation S703, the service server 200 may generate predictive fit data on the basis of the user body information and sample data. As described above with reference to FIG. 4, the predictive fit data may be generated according to a process of determining feature label information included in sample data which the user body information and the fashion item information match as the predictive fit data.

In operation S705, the service server 200 may provide the predictive fit data to the user, the offline store and/or a brand company of the fashion item.

The predictive fit data transmitted to the user can be utilized for virtual fitting when the user actually wears clothes of a similar size or style. Through the virtual fitting, an effect of reducing the hassle of users in trying on numerous clothes and reducing the time spent on shopping is provided.

In addition, when the predictive fit data is transmitted to the offline store or the brand company of the fashion item, the predictive fit data can be managed as customer information of the offline store or the brand company. Through this, there is an effect that the offline store and the brand company can provide customers with customized services, easily understand changing trends, and more accurately reflect the needs of users.

Specific embodiments are shown by way of example in the specification and the drawings and are merely intended to aid in the explanation and understanding of the technical spirit of the present invention rather than limiting the scope of the present invention. Those of ordinary skill in the technical field to which the present invention pertains should be able to understand that various modifications and alterations may be made without departing from the technical spirit or essential features of the present invention.

1. A system for providing fashion information, the system comprising:
a sample data generation unit configured to generate sample data in which the same fashion items of various sizes are matched according to human body information;
a sample data storage unit configured to store the sample data; and
a predictive fit data providing unit configured to upon receiving fashion item information and user body information from a user device, generate predicted fit data with reference to the stored sample data and provide the user device with the generated predictive fit data,
wherein the user body information includes basis body information and body characteristic information,
the body characteristic information includes at least one among information about a proportion of each part of a body of a user, information about a skin color of the user, and information about a skin tone of the user, and
the predictive fit data is data to be referred to by the user for a size or fit when selecting the fashion item, the predictive fit data including sample data that is retrieved in the stored sample data on the basis of the fashion item information and the user body information.

2. The system of claim 1, wherein the sample data generation unit is configured to:
generate basic sample data from captured images of models having various heights and weights directly wearing the same fashion items of various sizes; and
generate model sample data from captured images of models having various body characteristics directly wearing the same fashion items of various sizes.

3. The system of claim 1, wherein the sample data generation unit is configured to:
generate body three dimensional (3D) scanning data corresponding to 3D images of models having various heights, weights, and body characteristics;
generate fashion item 3D scanning data corresponding to 3D images of fashion items; and
generate the sample data on the basis of the body 3D scanning data and the fashion item 3D scanning data.

4. The system of claim 3, wherein the sample data generation unit is configured to:
generate the fashion item 3D scanning data and the body 3D scanning data through an image designed through an image editing program; and
generate the sample data on the basis of the fashion item 3D scanning data and the body 3D scanning data.

5. The system of claim 1, wherein the sample data generation unit generates the sample data through a machine learning model through a neural network model that is trained;
wherein the neural network model uses at least one of a deep neural network (DNN), a convolutional deep neural network (CNN), a recurrent neural network (RNN), and a deep belief network (DBN).

6. The system of claim 1, wherein the sample data storage unit is updated periodically to reflect various pieces of body information and to reflect information about fits that are generated or deleted over time.

7. The system of claim 1, wherein the predictive fit data providing unit is configured to provide the user device with a color determined to be suited to the skin color of the user or the skin tone of the user and feature label information included in the retrieved sample data as the predictive fit data,
the feature label information is information expressing the fit as a text, and
the fit is information expressing a human feeling derivable when the user wears the fashion item.

8. The system of claim 1, wherein the retrieved sample data is a single piece of sample data including a largest number of pieces of body information included in the user body information, or a plurality of pieces of sample data including at least one piece of body information included in the user body information, and
the plurality of pieces of sample data are arranged in descending order of the largest number of pieces of body information included in the user body information.

9. A method of providing fashion information, the method comprising:
generating, by a sample data generation unit, sample data in which the same fashion items of various sizes are matched according to human body information;
storing, by a sample data storage unit, the sample data; and
generating, by a predictive fit data providing unit, upon receiving fashion item information and user body information from a user device, predictive fit data with reference to the stored sample data and providing the user device with the generated predictive fit data,
wherein the user body information includes basic body information and body characteristic information,
the body characteristic information includes at least one among information about a proportion of each part of a body of a user, information about a skin color of the user, and information about a skin tone of the user, and
the predictive fit data is data to be referred to by the user for a size or fit when selecting the fashion item, the predictive fit data including sample data that is retrieved in the stored sample data on the basis of the fashion item information and the user body information.

10. The method of claim 9, wherein the generating of the sample data includes:
generating basic sample data from captured images models having various heights and weights directly wearing the same fashion items of various sizes; and
generating model sample data from captured images models having various body characteristics directly wearing the same fashion items of various sizes.

11. The method of claim 9, wherein the generating of the sample data includes:
generating body three dimensional (3D) scanning data corresponding to 3D images of models having various heights, weights, and body characteristics;
generating fashion item 3D scanning data corresponding to 3D images of fashion items; and
generating the sample data on the basis of the body 3D scanning data and the fashion item 3D scanning data.

12. The method of claim 11, wherein the generating of the sample data includes:
generating the fashion item 3D scanning data and the body 3D scanning data through an image designed through an image editing program; and
generating the sample data on the basis of the fashion item 3D scanning data and the body 3D scanning data.

13. The method of claim 9, wherein the generating of the sample data includes generating the sample data through a machine learning model through a neural network model that is trained;
wherein the neural network model uses at least one of a deep neural network (DNN), a convolutional deep neural network (CNN), a recurrent neural network (RNN), and a deep belief network (DBN).

14. The method of claim 9, wherein the storing of the sample data includes periodically updating the sample data to reflect various pieces of body information and reflect information about fits that are generated or deleted over time.

15. The method of claim 9, wherein the providing of the predictive fit data to the user device includes providing the user device with a color determined to be suited to the skin color of the user or the skin tone of the user and feature label information included in the retrieved sample data as the predictive fit data,
the feature label information is information expressing the fit as a text, and
the fit is information expressing a human feeling derivable when the user wears the fashion item.

16. The method of claim 9, wherein the retrieved sample data is a single piece of sample data including a largest number of pieces of body information included in the user body information, or a plurality of pieces of sample data including at least one piece of body information included in the user body information, and
the plurality of pieces of sample data are arranged in descending order of the largest number of pieces of body information included in the user body information.
